(19) United States
(12) Patent Application Publication
(10) Pub. No.: US 2007/0145273 A1
(43) Pub. Date: Jun. 28, 2007

(54) High-sensitivity infrared color camera

(76) Inventor: Edward T. Chang, Cambridge, MA (US)

Correspondence Address: Daniel E. Ovanezian;BLAKELY, SOKOLOFF, TAYLOR & ZAFMAN LLP, Seventh Floor, 12400 Whishire Boulevard, Los Angeles, CA, 90025, US

(21) Appl. No.: 11/317,129

(22) Filed: Dec. 22, 2005

(51) Int. Cl. G01J 5/00

(52) U.S. Cl. 250/338.1; 250/226

(57) ABSTRACT

A method in a high-sensitivity infrared color camera includes selectively passing visible spectral energy and non-visible spectral energy through a color filter array, generating a color image corresponding to a spatial distribution of the visible and non-visible spectral energy from the color filter array, and mapping the spatial distribution of the visible and non-visible spectral energy to a spatial distribution of visible spectral energy in a corrected color image.

### TECHNICAL FIELD

Embodiments of the present invention are related to digital color imaging and, in particular, to the use of non-visible spectral energy to enhance the sensitivity of digital color imaging systems.

### BACKGROUND

Conventional digital cameras utilize CMOS (complementary metal oxide semiconductor) or CCD (charge-coupled device) imaging arrays to convert electromagnetic energy to electrical signals that can be used to generate digital images on display devices (e.g., cathode ray display systems, LCD displays, plasma displays and the like) or printed photographs on digital printing devices (e.g., laser printers, inkjet printers, etc.). The imaging arrays typically include rows and columns of individual cells (sensors) that produce electrical signals corresponding to a specific location in the digital image. In typical digital cameras, a lens focuses electromagnetic energy that is reflected or emitted from a photographic object or scene onto the imaging surface of the imaging array.

CMOS and CCD image sensors are responsive (i.e., convert electromagnetic energy to electrical signals) to spectral energy within the spectral energy band that is visible to humans (the visible spectrum), as well as infrared spectral energy that is not visible to humans. In a black and white (monochrome) digital camera, as illustrated in FIG. 1A, virtually all of the available visible and infrared energy is allowed to reach the imaging array. As a result, the sensitivity of the monochrome camera is improved by the response of the CMOS or CCD image sensors to the infrared spectral energy, making monochrome digital cameras very effective in low light conditions.

In conventional digital color cameras, as illustrated in FIG. 1B, a color filter array (CFA) is interposed between the imaging array and the camera lens to separate color components of the image. Pixels of the CFA have a one-to-one correspondence with the pixels of the imaging array. The CFA typically includes blocks of pixel color filters, where each block includes at least one pixel color filter for each of three primary colors, most commonly red, green and blue. One common CFA is a Bayer array. In a Bayer array, as illustrated in FIG. 1B, each block is a 2×2 block of pixel color filters including one red filter, two green filters and one blue filter. The ratio of one red, two green and one blue filters reflects the relative sensitivity of the human eye to the red, blue and green frequency bands in the visible color spectrum (i.e., the human eye is approximately twice as sensitive in the green band as it is in the red or blue bands). Other CFA configurations representing the sensitivity of the human eye are possible and are known in the art, including complementary color systems.

Conventional monochrome and color digital cameras also include an image processing function. Image processing is used for gamma (brightness) correction, demosaicing (interpolating pixel colors), white balance (to adjust for different lighting conditions) and to correct for sensor crosstalk.

The RGB filter elements in the CFA's are not perfect. About 20% of the visible spectral energy is lost, and in addition to their intended color band, each pixel filter passes energy in the infrared band that can distort the color balance. Instead of passing only red (R) or green (G) or blue (B) spectral energy, each filter also passes some amount of infrared (I) energy. Absent any measures to block the infrared energy, the output of each “color” pixel of the imaging array will be contaminated with the infrared energy that passes through that particular color filter. As a result, the output from the red pixels will be (R+I_{R}), the output from the green pixels will be (G+I_{G}) and the output from the blue pixels will be (B+I_{B}). The apparent ratios of the R, G and B components, which determine the perceived color of the image, will be distorted. To overcome this problem, conventional color cameras interpose an infrared (IR) filter between the light source and the CFA, as illustrated in FIG. 1B, to remove the infrared energy before it can generate false color signals in the imaging array. Like the CFA, however, the IR filter is imperfect. By blocking the infrared energy, it blocks approximately 60% of the spectral energy available to the imaging array sensor. Therefore, in comparison to a monochrome digital camera, a conventional digital color camera is only about one-third as sensitive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention is illustrated by way of example, and not by way of limitation, in the figures of the accompanying drawings in which:

FIG. 1A illustrates a monochrome camera;

FIG. 1B illustrates infrared filtering in a conventional color camera;

FIG. 2 illustrates a color filter array in one embodiment;

FIG. 3 illustrates virtual infrared filtering in one embodiment;

FIG. 4 illustrates spectral mapping in one embodiment;

FIG. 5A illustrates the output of a conventional color camera;

FIG. 5B illustrates the output of a color camera without an IR filter;

FIG. 5C illustrates the output of a color camera with a virtual IR filter in one embodiment;

FIG. 6 is a block diagram illustrating the apparatus in one embodiment of a high-sensitivity infrared color camera; and

FIG. 7 is a flowchart illustrating a method in one embodiment of a high-sensitivity infrared color camera.

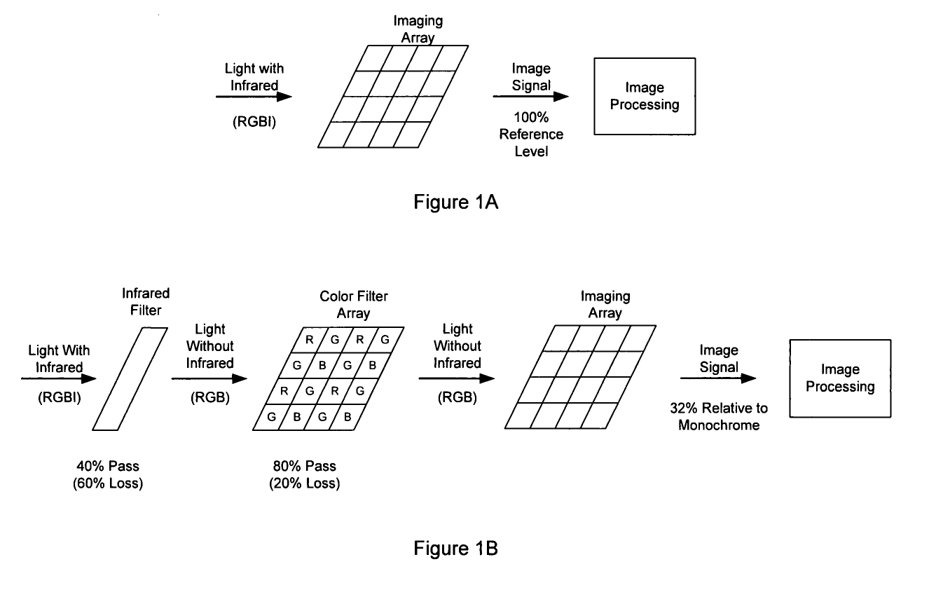

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. As used herein, the terms “image” or “color image” may refer to displayed or viewable images as well as signals or data representative of displayed or viewable images. The term “light” as used herein may refer to electromagnetic energy that is visible to humans or to electromagnetic energy that is not visible to humans. The term “coupled” as used herein, may mean electrically coupled, mechanically coupled or optically coupled, either directly or indirectly through one or more intervening components and/or systems.

Unless stated otherwise as apparent from the following discussion, it will be appreciated that terms such as “processing,” “mapping,” “acquiring,” “generating” or the like may refer to the actions and processes of a computer system, or similar electronic computing device, that manipulates and transforms data represented as physical (e.g., electronic) quantities within the computer system's registers and memories into other data similarly represented as physical within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

Methods and apparatus for a high-sensitivity infrared color camera are described. In one embodiment, an apparatus includes means for detecting infrared light and visible light, and software means for filtering the infrared light. In one embodiment, the apparatus also includes means for increasing the sensitivity of the apparatus using the detected infrared light.

In one embodiment, the apparatus includes: a color filter array to selectively pass both visible spectral energy and infrared spectral energy; an imaging array coupled with the color filter array to capture a color image corresponding to a distribution of the visible spectral energy and the infrared spectral energy from the color filter array, and to generate signals corresponding to the distribution; and a processing device coupled to the imaging array to map the signals corresponding to the distribution of visible and infrared spectral energy to signals corresponding to a distribution of visible spectral energy in a corrected color image.

In one embodiment, a method for a high-sensitivity infrared color camera includes selectively passing visible and non-visible spectral energy through a color filter array, generating a color image corresponding to a spatial distribution of the visible and non-visible spectral energy from the color filter array, and mapping the spatial distribution of the visible and non-visible spectral energy to a spatial distribution of visible spectral energy in a corrected color image.

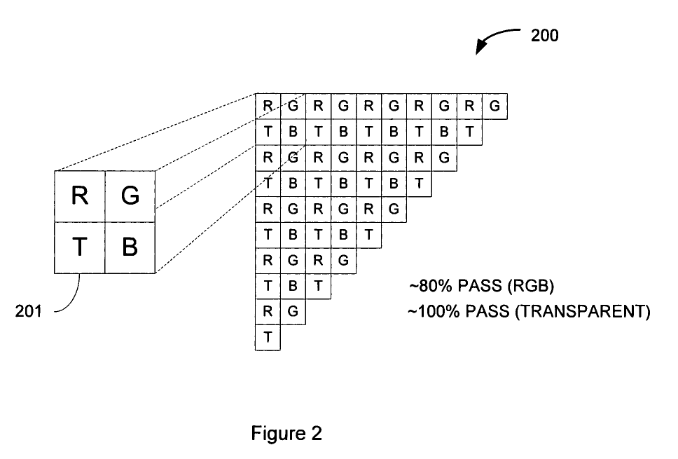

FIG. 2 illustrates a portion of a color filter array (CFA) 200 in one embodiment of the invention. CFA 200 may contain blocks of pixels, such as exemplary block 201. Block 201 may contain a red (R) pixel filter to pass spectral energy in a red color band, a green (G) pixel filter to pass spectral energy in a green color band, a blue (B) pixel filter to pass spectral energy in a blue color band, and a transparent (T) pixel to pass visible spectral energy in the red, green and blue color bands as well as infrared spectral energy. In one embodiment, each of the color pixel filters (R, G and B) may pass approximately 80 percent of the spectral energy in its respective color band and approximately 80 to 100 percent of the incident infrared energy. The transparent pixels transmit approximately 100 percent of the visible and infrared spectral energy. It will be appreciated that in other embodiments, different configurations of pixel blocks may be used to selectively pass visible and infrared spectral energy. For example, pixel blocks may contain more than four pixels and the ratios of red to green to blue to transparent pixels may be different than the 1::1::1::1 ratio illustrated in FIG. 2.

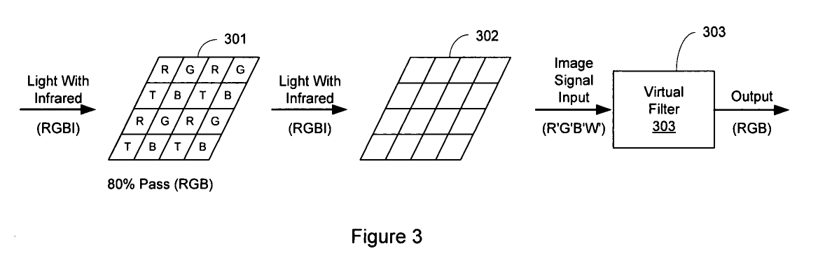

FIG. 3 illustrates the operation of a high-sensitivity infrared color camera in one embodiment. In FIG. 3, light that is reflected or emitted from a photographic object (not shown) is focused on a CFA 301, which may be similar to CFA 200. CFA 301 may be physically aligned and optically coupled with imaging sensor 302 having panchromatic pixel sensors responsive to visible and infrared spectral energy. Each pixel block in CFA 301 may have a corresponding pixel sensor block in imaging array 302. Each pixel sensor in the imaging array 302 may generate an electrical signal in proportion to the spectral energy incident on the corresponding pixel sensor from the CFA 301. That is, a pixel sensor aligned with a red pixel filter will generate a signal proportional to the R and I energy passed by the red filter, a pixel sensor aligned with a green pixel filter will generate a signal proportional to the G and I energy passed by the green filter, a pixel sensor aligned with a blue pixel filter will generate a signal proportional to the B and I energy passed by the blue filter, and a pixel sensor aligned with a transparent pixel will generate a signal proportional to the R, G, B and I energy passed by the transparent filter. The electrical signals thus generated represent a color image corresponding to the spatial distribution of the visible and infrared spectral energy from the color filter array.

The electrical signals may be converted to digital signals within the imaging array 302 or in an analog-to-digital converter following the imaging array 302 (not shown). The digitized electrical signals may be transmitted to a virtual filter 303 where the electrical signals may be processed as described below.

As described above, each block of pixel sensors in the imaging array 302 generates a set of signals corresponding to the red, green, blue and transparent pixels in the CFA 301. That is, Imaging array 302 generates a “red” (R′) signal proportional to R+I energy passed by the red filter, a “green” (G′) signal proportional to G+I energy passed by the green filter, a “blue” (B′) signal proportional to B+I energy passed by the blue filter, and a “white” (W′) signal (signifying all colors plus infrared) proportional to the R+G+B+I energy passed by the transparent pixel. The ratios of the R′, G′ and B′ will different than the R::G::B ratios in a true-color image of the photographic object. That is,

$$\begin{matrix}\frac{{R}^{′}}{{G}^{′}} = \frac{R + I}{G + I} \neq \frac{R}{G} & ( 1.1 ) \\ \frac{{R}^{′}}{{B}^{′}} = \frac{R + I}{B + I} \neq \frac{R}{B} \\ and & ( 1.2 ) \\ \frac{{G}^{′}}{{B}^{′}} = \frac{G + I}{B + I} \neq \frac{G}{B} & ( 1.3 )\end{matrix}$$

Virtual filter 303 may be configured to map the spatial distribution of the visible and infrared energy from each block of pixel sensors, represented by the digitized electrical signals as described above, to a different spatial distribution that corresponds to the spatial distribution of visible spectral energy in a corrected color image.

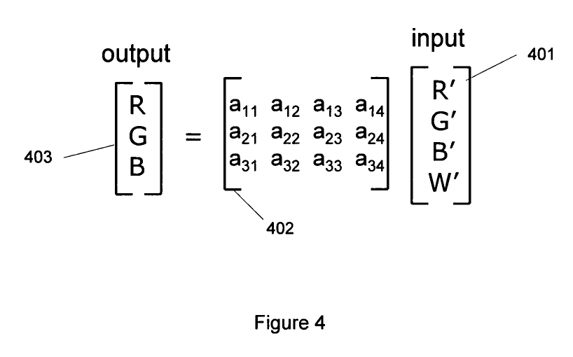

In one embodiment, virtual filter 303 may implement a linear transformation as illustrated in FIG. 4A. In FIG. 4A, an input vector 401 (representing the output signals from a pixel block of imaging array 302 ) includes R′, G′, B′ and W′ signal values as described above. Vector 401 may be multiplied by a 4×3 matrix of coefficients 402 to yield a vector 403 having corrected R, G and B signal components corresponding to a corrected color image. That is, the linear transformation produces a set of corrected color components, as follows[CEI]:
R=a₁₁R′+a₁₂G′+a₁₃B′+a₁₄W′
G=a₂₁R′+a₂₂G′+a₂₃B′+a₂₄W′
B=a₃₁R′+a₃₂G′+a₃₃B′+a₃₄W′ (1.4)

The coefficients aᵢⱼ may be determined analytically, based on known or measured transmission coefficients of the filtered and transparent pixels in CFA 301, and the conversion efficiencies of the pixel sensors in the imaging array 302 in each spectral energy band. Alternatively, using a standard color test pattern as a photographic object, the RGB outputs (reference image) of a conventional color camera (i.e., with an analog IR filter and a conventional color filter such as a Bayer filter) may be compared with the RGB outputs of the virtual filter 303. The coefficients may be modified using a search algorithm (e.g., a gradient search algorithm or the like) to minimize a difference measure (e.g., a sum of squared differences or root mean square difference) between the reference image and the image produced using CFA 302 and virtual filter 303. The difference measure may be designed to match the R::G::B ratios of the two images because the outputs of the virtual filter 303 have may a greater absolute value, as described below.

As noted above, the R, G and B color filter pixels in CFA 301 may pass approximately 80 percent of the incident spectral energy, and the transparent pixels may pass approximately 100 percent of the incident spectral energy. Because 75 percent (3 of 4) of the pixels in CFA 301 are color filter pixels and 25 percent of the pixels in CFA 301 are transparent, the total energy available for image processing will be approximately:
E=0.75(0.80)+0.25(1.0)=0.85 (1.5)
That is, approximately 85 percent of the incident spectral energy may be available at the output of the virtual filter 303. In contrast, as noted above, the RGB output of a conventional color camera represents only about 30 percent of the incident spectral energy. Thus, for a given imaging array technology (e.g., CMOS or CCD), the output signal to noise ratio (SNR_{O}) of the virtual filter may be almost three times the SNR_{O} of a conventional color camera under the same lighting conditions.

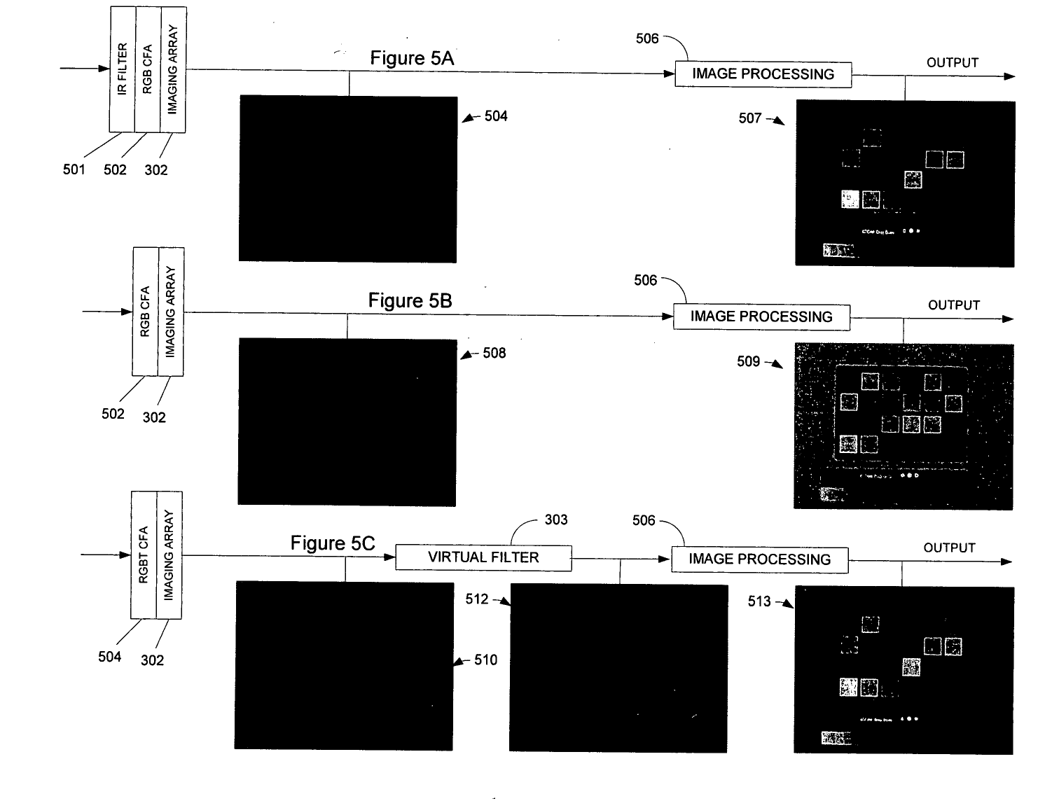

FIGS. 5A through 5C illustrate images obtained with a conventional color camera (FIG. 5A), with the IR filter removed from the conventional color camera (FIG. 5B) and with an embodiment of the present invention (FIG. 5C). Each of FIGS. 5A through 5C also includes a conventional image processing block 506, as described above.

In FIG. 5A, light with infrared energy passes through IR Filter 501 so that light without infrared energy passes through RGB color filter array 502 to imaging array 302. Imaging array 302 generates a raw color image 504. Image processing 506 then generates output image 507 from the raw color image 504. In FIG. 5B, light with infrared energy passes through RGB color filter array 502 to imaging array 302. Imaging array 302 generates raw color image 508 (contaminated with infrared energy). Image processing 506 then generates output image 509 from the raw color image 508. In FIG. 5C, light with infrared energy passes through RGBT color filter array 301 to imaging array 302. Imaging array 302 generates raw color image 510, which represents the uncorrected distribution of R, G, B and I energy over imaging array 302. Virtual filter 303 corrects the distribution of R, G, B and I energy, as described above, in accordance with a selected set of transformation coefficients. The output of virtual filter 303 is a corrected color image 512. Image processing 506 then converts image 512 to output image 513.

Comparing output image 509 in FIG. 5B (IR filter removed) with output image 507 in FIG. 5A (conventional camera with IR filter), it can be seen that the image is brighter due to the presence of infrared energy, but that the colors are also distorted and washed-out by the presence of the infrared energy. The colors are wrong because the infrared energy contaminates the R, G and B pixels and upsets the color balance. The colors are washed-out because the infrared energy is approximately evenly distributed over all of the R, G and B pixels, creating a “white light” bias that reduces the saturation of the colors.

Comparing output image 513 in FIG. 5C (embodiment of the present invention) with output image 507, it can be seen that the color match is subjectively good.

The selection of the coefficients aᵢⱼ in the virtual filter 303 will depend on the ambient light source that illuminates the photographic object. Different light sources emit different levels of R, G, B and I spectral energy. For example, sunlight, incandescent light and fluorescent light all have different spectral energy content. In one exemplary embodiment using incandescent light, for example, the following coefficients minimized a root mean square (RMS) difference measure between a reference image (e.g., image 507 ) and a corrected image (e.g., image 513 ):
R=0.344R′−0.638G′−2.082B′+1.991W′
G=−1.613R′+1.471G′−1.94B′+2.016W′
B=−1.304R′−1.446G′+0.776B′+1.954W′ (1.6)

Other classes of mapping functions may be used for virtual filtering. For example, a piecewise linear function or nonlinear mapping function may be used to correct for non-linearities in an imaging array, such as imaging array 302. In other embodiments, the mapping function may be a multi-level mapping function with two or more coefficient matrices.

Noise may arise in a digital camera from several sources including thermal noise, quantum noise, quantization noise and dark current. In general, these noise sources are random processes that respond differently to the coefficients in a linear transformation such as the linear transformation of equation 1.6 above. Therefore, in one embodiment, a minimization function maybe defined to minimize the absolute noise output of the virtual filter, such as, for example, noise gain compared to a conventional color camera.

In one embodiment, matrix coefficients aᵢⱼ may also be chosen to mimic the performance of a monochrome digital camera by redistributing the spectral energy to obtain a high-sensitivity, low color mode (e.g., by equalizing the R, G and B outputs of the virtual filter). For example, the coefficient set

$$( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34}\end{matrix} ) = ( \begin{matrix}0 & 0 & 0 & 1 \\ 0 & 0 & 0 & 1 \\ 0 & 0 & 0 & 1\end{matrix} ) \qquad ( 1.7 )$$

will produce a pure monochrome output where R=G=B=W′.

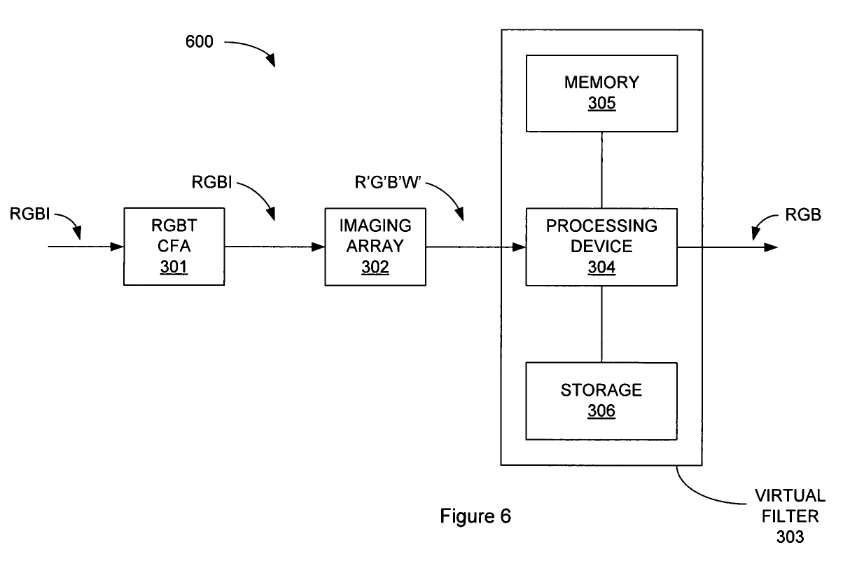

FIG. 6 illustrates an apparatus 600 in one embodiment. The apparatus 600 includes CFA 301 and imaging array 302 as described above. Virtual filter 303 may include a processing device 304, which may be any type of general purpose processing device (e.g., a controller, microprocessor or the like) or special purpose processing device (e.g., an application specific integrated circuit, field programmable gate array, digital signal processor or the like). Virtual filter 303 may also include a memory 305 (e.g., random access memory or the like) to store programming instructions for processing device 304, corrected and uncorrected color images and other processing variables such as transformation coefficients, for example. Virtual filter 303 may also include a storage element 306 (e.g., a non-volatile storage medium such as flash memory, magnetic disk or the like) to store programs and settings. For example, storage element 306 may contain sets of transformation coefficients for virtual filter 303 corresponding to different lighting conditions such as sunlight, incandescent light, fluorescent lighting or low/night lighting, for example, as well as monochrome settings as described above. Virtual filter 303 may also include a user interface (not shown) for selecting the ambient lighting conditions or operating mode (e.g., color or monochrome) in which the camera will be used so that the proper coefficient set may be selected by the processing device 304 (e.g., to compensate the corrected color images for different ambient lighting conditions or to set the operating mode).

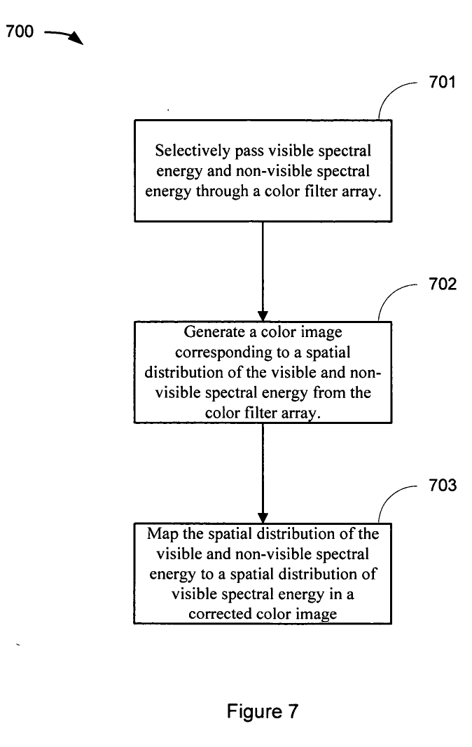

In one embodiment illustrated in FIG. 7, a method 700 in a high-sensitivity infrared color camera includes selectively passing visible spectral energy and non-visible spectral energy through a color filter array, such as CFA 302 (step 701); generating a color image, in an imaging device such as imaging array 302, corresponding to a spatial distribution of the visible and non-visible spectral energy from the color filter array (step 702); and mapping the spatial distribution of the visible and non-visible spectral energy to a spatial distribution of visible spectral energy in a corrected color image, in a virtual filter such as virtual filter 303 (step 703).

It will be apparent from the foregoing description that aspects of the present invention may be embodied, at least in part, in software. That is, the techniques may be carried out in a computer system or other data processing system in response to its processor, such as processing device 304, for example, executing sequences of instructions contained in a memory, such as memory 305, for example. In various embodiments, hardware circuitry may be used in combination with software instructions to implement the present invention. Thus, the techniques are not limited to any specific combination of hardware circuitry and software or to any particular source for the instructions executed by the data processing system. In addition, throughout this description, various functions and operations may be described as being performed by or caused by software code to simplify description. However, those skilled in the art will recognize what is meant by such expressions is that the functions result from execution of the code by a processor or controller, such as processing device 304.

A machine-readable medium can be used to store software and data which when executed by a data processing system causes the system to perform various methods of the present invention. This executable software and data may be stored in various places including, for example, memory 305 and storage 306 or any other device that is capable of storing software programs and/or data.

Thus, a machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM); random access memory (RAM); magnetic disk storage media; optical storage media; flash memory devices; etc.), as well as electrical, optical, acoustical or other forms of propagated signals (e.g., carrier waves, infrared signals, digital signals, etc.); etc.

It should be appreciated that references throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention. In addition, while the invention has been described in terms of several embodiments, those skilled in the art will recognize that the invention is not limited to the embodiments described. The embodiments of the invention can be practiced with modification and alteration within the scope of the appended claims. The specification and the drawings are thus to be regarded as illustrative instead of limiting on the invention.

What is claimed is:

1. An apparatus, comprising:
means for detecting infrared energy; and
software means for filtering the infrared energy.

2. The apparatus of claim 1, further comprising means for increasing sensitivity of the apparatus using the detected infrared energy.

3. The apparatus of claim 1, further comprising a color filter coupled to the means for detecting infrared energy, wherein the color filter has a pattern comprising 2×2 blocks of pixels composed of one red, one blue, one green and one transparent pixel.

4. An apparatus, comprising:
a color filter array to selectively pass visible spectral energy and infrared spectral energy;
an imaging array, optically coupled with the color filter, to capture a color image corresponding to a spatial distribution of the visible and the infrared spectral energy from the color filter array and to generate signals corresponding to the distribution; and
a processing device, coupled with the imaging array, to apply a mapping function to map the signals corresponding to the distributions of the visible and infrared spectral energy to signals corresponding to a distribution of visible spectral energy in a corrected color image.

5. The apparatus of claim 4, wherein the processing device is configured to select a mapping function based on ambient lighting conditions.

6. The apparatus of claim 5, wherein the ambient lighting conditions comprise one of incandescent lighting, fluorescent lighting, natural lighting and low-level lighting.

7. The apparatus of claim 4, wherein the color filter comprises blocks of pixel filters, and wherein each block comprises:
a first color pixel filter to pass spectral energy in a first color band and an infrared energy band;
a second color pixel filter to pass spectral energy in a second color band and the infrared energy band;
a third color pixel filter to pass spectral energy in a third color band and the infrared energy band; and
a transparent pixel to pass spectral energy in the first color band, the second color band, the third color band and the infrared energy band.

8. The apparatus of claim 4, wherein the imaging array comprises blocks of panchromatic pixel sensors corresponding to the blocks of pixel filters of the color filter.

9. The apparatus of claim 4, wherein the mapping function is one of a linear mapping function, a piecewise linear mapping function and a non-linear mapping function.

10. The apparatus of claim 4, wherein the mapping function mimics a monochrome camera response.

11. The apparatus of claim 4, wherein each block of pixel filters comprises a red filter, a blue filter, a green filter and a transparent filter.

12. A method, comprising:
selectively passing visible spectral energy and non-visible spectral energy through a color filter array;
generating a color image corresponding to a spatial distribution of the visible and non-visible spectral energy from the color filter array; and
mapping the spatial distribution of the visible and non-visible spectral energy to a spatial distribution of visible spectral energy in a corrected color image.

13. The method of claim 12, wherein mapping the visible and non-visible spectral energy comprises:
generating signals corresponding to the spatial distribution of the visible and non-visible spectral energy; and
applying a mapping function to the signals; and
generating signals corresponding to a distribution of visible spectral energy in the corrected color image.

14. The method of claim 13, wherein the mapping function is based on ambient lighting conditions.

15. The method of claim 14, wherein the ambient lighting conditions comprise one of incandescent lighting, fluorescent lighting, natural lighting and low-level lighting.

16. The method of claim 12, wherein the color filter array comprises blocks of pixel filters, and wherein selectively passing the visible spectral energy and the non-visible spectral energy through the color filter comprises, in each block:
passing spectral energy in a first color band and a non-visible energy band through a first color pixel filter;
passing spectral energy in a second color band and the non-visible energy band through a second color pixel filter;
passing spectral energy in a third color band and the non-visible energy band through a third color pixel filter; and
passing spectral energy in the first color band, the second color band, the third color band and the non-visible energy band through a transparent pixel filter.

17. The method of claim 13, wherein the mapping function is one of a linear mapping function, a piecewise linear mapping function and a non-linear mapping function.

18. The method of claim 12, wherein the mapping function is selected to mimic the response of a monochrome camera.

19. An article of manufacture comprising a machine-accessible medium including data that, when accessed by a machine, cause the machine to perform operations comprising:
generating a color image from visible spectral energy and non-visible spectral energy; and
correcting the color image for the non-visible spectral energy while retaining the non-visible spectral energy in a corrected color image.

20. The article of manufacture of claim 19, wherein the machine-accessible medium further includes data that cause the machine to perform operations comprising:
compensating the corrected color image for a plurality of ambient lighting conditions.
